(19) United States
(12) Patent Application Publication
(10) Pub. No.: US 2012/0198828 A1
(43) Pub. Date: Aug. 9, 2012

(54) HYDRODYNAMIC TORQUE CONVERTER

(75) Inventor: Christine BUEDENBENDER, BUEHLERTAL (DE)

(73) Assignee: SCHAEFFLER TECHNOLOGIES AG & CO. KG, Buehlertal (DE)

(21) Appl. No.: 13/449,801

(22) Filed: Apr. 18, 2012

Related U.S. Application Data
(63) Continuation of application No. PCT/DE2010/001157, filed on Sep. 30, 2010.

(30) Foreign Application Priority Data
Oct. 19, 2009 (DE) 10 2009 049 884.2

(51) Int. Cl. F16H 41/26; F01D 9/00; F01D 5/14

(52) U.S. Cl. 60/365; 416/223 R; 416/182

(57) ABSTRACT

The invention relates to a hydrodynamic torque converter comprising an impeller (12) arranged. inside a housing and a turbine (14) and at least one stator blade (18) of a stator (16) arranged between the impeller and the turbine, the rear blade surface of the stator blade having a flat section (30).

### CROSS-REFERENCE TO RELATED APPLICATIONS

This application is a continuation of PCT/DE2010/001157 filed Sep. 30, 2010, which in turn claims the priority of DE 10 2009 049 884.2 filed Oct. 19, 2009. The priority of these applications is hereby claimed and these applications are incorporated by reference herein.

### FIELD OF THE INVENTION

The invention relates to a hydrodynamic torque converter.

### BACKGROUND OF THE INVENTION

Such hydrodynamic torque converters are generally known. For example, DE 198 47 372 B4 discloses a hydrodynamic torque converter that has an impeller Which rs connected to a drive side, a turbine, which is connected to an output side and a stator, which is arranged between the latter and has a plurality of stator blades. In this context, the turbine, the impeller, and the stator are surrounded by a housing within which a fluid is introduced. The fluid can produce a hydrodynamically effective connection between the impeller and the turbine, The stator blade has a blade surface which comprises a blade front edge facing the turbine and a blade rear edge facing the impeller, Extending between the blade front edge is a blade front surface which lies essentially opposite the turbine and a blade rear surface which lies essentially opposite the impeller. The blade front surface has here a planar region, which is formed by a flattened portion and, as a result of which, the torque take-up behavior of the hydrodynamic torque converter, in particular of the impeller at a low rotational speed ratio, corresponding to the ratio of the rotational speed of the turbine and of the impeller, is improved.

### SUMMARY OF THE INVENTION

The invention relates to providing a hydrodynamic torque converter with an improved torque take-up behavior, predominantly in the case of high rotational speed ratios.

Accordingly, the invention provides a hydrodynamic torque converter which has an impeller arranged inside a housing and a turbine and a stator that has at least one stator blade arranged between the impeller and the turbine. The stator blade comprises a blade front edge facing the turbine and a blade rear edge facing the impeller, and a profile depth which indicates the shortest distance between the blade front edge and the blade rear edge. Furthermore, the stator blade has a blade front surface which extends between the blade front edge and the blade rear edge and lies essentially opposite the turbine, and a blade rear surface, which has a planer region and lies essentially opposite the impeller, The planar region can be formed by a flattened portion of the original blade profile. In the case of certain rotational speed ratios, in particular in the case of large rotational speed ratios, when a fluid flows against the stator blade the obstruction of the flow occurring as a result of the stator blade cross-section which is projected perpendicularly with respect to the direction of flow can be reduced and the torque take-up behavior of the hydrodynamic torque converter can be improved.

In one embodiment, the planar region has a length which is perpendicular with respect to a radial direction and runs parallel to a tangent of the blade rear surface perpendicular to the radial direction. A ratio between the region length and the profile depth is advantageously in a range between 0 and 0.75.

The expressions “radial” and “axial” refer to a rotational axis of the hydrodynamic torque converter, “Radial” harms a location reference in a plane perpendicular to the rotational axis in a radial direction and “axial” forms a location. reference along the rotational axis or a line parallel to the rotational axis.

In another embodiment of the invention, the planar region forms an angle with an axial direction running parallel to the rotational axis of the hydrodynamic torque converter. The angle is preferably in a range between 0 degrees and 90 degrees, in particular between 0 degrees and 60 degrees. The angle and/or the region length can preferably be varied in the radial direction over the extent of the stator blade. For example, the arrangement of the planar region on the stator blade and the profile thereof in the radial direction can be selected in the form of the angle and the region length as a function of the desired influence on the characteristic curve of the torque converter.

In a further embodiment of the invention, the blade rear surface is of convex design and the blade front surface is of concave design. In yet a further embodiment, the stator blade has essentially an airfoil profile, for example an NCA profile, when viewed in a cross-section perpendicular to a radial direction.

In an even further embodiment of the invention, the junction between the planar region and the blade rear surface is of a continuous design. As a result, an optimum flow around the junction region can be brought about.

Further advantages and advantageous refinements of the invention are the subject matter of the following figures and the described parts thereof, which have not been illustrated true to scale for the sake of clarity.

### BRIEF DESCRIPTION OF THE DRAWINGS

In the drawings, in particular:

FIG. 1: shows a detail of a eross-section through a hydrodynamic torque converter according to the invention;

FIG. 2: shows a cross section through a stator blade of the hydrodynamic torque converter along the line A-A from FIG. 1; and

FIG. 3: shows a diagram with performance curves of the torque converter according to the invention compared to performance curves of a hydrodynamic torque converter according to the prior art.

### DETAILED DESCRIPTION OF THE INVENTION

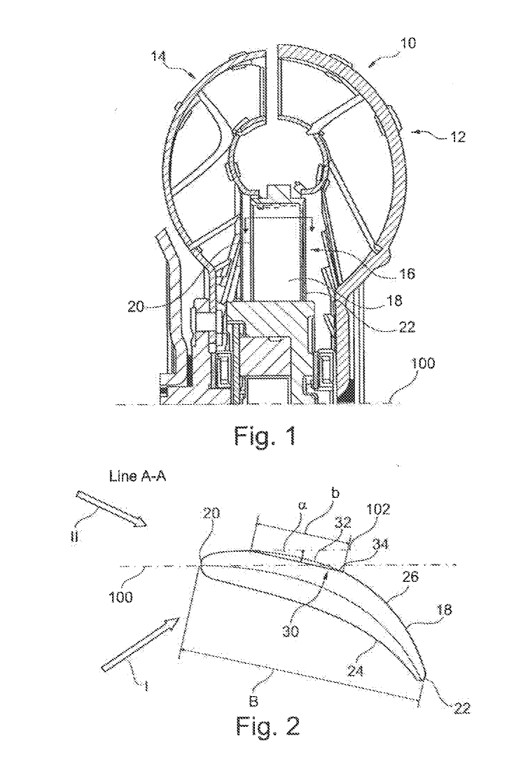

FIG. 1 illustrates a detail of a cross-section in a plane through a hydrodynamic torque converter 10 according to the invention. The plane is defined by the rotational axis 100 and a radial direction. Arranged inside a housing (not illustrated here), are an impeller 12, connected to a drive side, for example to an internal combustion engine, and a turbine 14, connected to an output side, for example a transmission. Inside the housing there is a fluid which, when the impeller 12 is driven, emerges radially from the impeller 12 and enters the turbine 14. A stator 16 is arranged axially between the turbine 14 and the impeller 12 in such a way that said stator 16 influences the flow of fluid, for example boosts the fluid pressure acting on the turbine 14, as a function of the rotational speed ratio between the rotational speed of the turbine 14 and that of the impeller 12. For this purpose, the stator 16 has a plurality of stator blades 18 whose blade surface has a blade front edge 20 facing the turbine 14 and a blade rear edge 22 facing the impeller 12.

FIG. 2 shows a stator blade 16 in a cross-section along the line A-A from FIG. 1. Extending between the blade front edge 20 and the blade rear edge 22 are the blade front surface 24, which is in contact with the fluid and lies essentially opposite the turbine 14, and the blade rear surface 26 lying essentially opposite the impeller 12. The blade rear surface 26 comprises a planar region 30 which extends in sections with the region length b. In comparison, the surface profile 32 of the blade rear surface of a stator blade according to the prior art is indicated by the dotted curve. The orientation of the planar region 30, which means the direction of the region length b, is aligned with a tangent of the blade rear surface 26 which is perpendicular with respect to the radial direction. The junction 34 between the planar region 30 and the blade rear surface 26 may be of continuous design, for example the junction can have a convex shape with one or more radii, when viewed in cross-section.

The extent of the stator blade 18 has a profile depth B which defines the shortest distance between the blade front edge 20 and the blade rear edge 22. The extent of the planar region 30 can be set in relation to the profile depth B. The planar region 30 is therefore advantageously embodied in such a way that the ratio b/B between the region length b and the profile depth B is in a range between 0 and 0.75.

Furthermore, the planar region 30 encloses, with an axial direction 102 running parallel to the rotational axis 100, an angle α, for example an angle a in a range between 0 degrees and 90 degrees, in particular between 0 degrees and 60 degrees. The larger the angle a for a given ratio b/B, the closer the planar region 30 is located to the blade rear edge 22 in this exemplary embodiment of the stator blade 18. In FIG. 1, the ratio b/B is approximately 0.35 and the angle a is 15 degrees, If the angle a and also the ratio b/B were larger, the stator blade 18 would therefore be shortened to a greater extent with respect to the original profile without a planar region 30 than in the exemplary embodiment.

The shape of the stator blade 18 has essentially an airfoil profile when viewed in a cross-section perpendicularly with respect to a radial direction. The blade rear surface 26 is therefore of convex design and the blade front surface 24 is of concave design and produces together an NACA profile. The formation of the planar region 30 and the blade rear surface 26 results in only a small change in the flow property of the stator blade 18 when a fluid flows from the direction I, such as appears, for example, in the case of a small rotational speed ratio between the rotational speed of the turbine 14 and the rotational speed of the impeller 12, compared to a stator blade according to the prior art which is indicated by the dashed line. The performance features of the hydrodynamic torque converter 10 which can be derived from the flow properties of the stator blade 18, such as the torque take-up behavior of the impeller 12 and the torque ratio, are influenced only to a small extent.

If the rotational speed ratio increases further to large rotational speed ratios, the flow of the fluid is, for example, in the direction II. In this case, the stator blade 18 forms a relatively small obstruction of the flow path of the fluid compared to a stator blade according to the prior art which has the surface profile 32. The planar region 30 accordingly causes a reduction in the cross-sectional area of the stator blade 18 which is projected perpendicularly onto the direction of the flow resulting in more mass flow of the fluid to be fed through the stator 16 and the torque take-up behavior to be increased while there is little influence on the torque ratio.

The stator blade 18 can be manufactured, for example, by casting. The casting mold is produced in such a way that the planar region 30 is generated on the blade rear surface 26 of the stator blade 18.

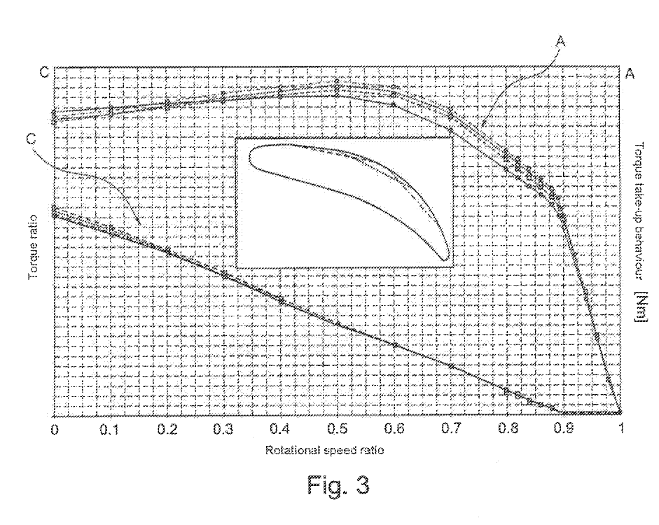

FIG. 3 shows a diagram with performance curves of the torque converter 10 according to the invention in comparison with performance curves of a hydrodynamic torque converter according to the prior art. The curve group A characterizes the torque take-up behavior of the impeller, and the curve group C characterizes the torque ratio between the torque which is present at the turbine and the torque of the hydrodynamic torque converter which is present at the impeller, as a function of the rotational speed ratio. The sketch-like illustration of the cross-section through a stator blade in the diagram illustrates the differences between the individual performance curves of a category A or C, The position and extent of the planar region on the blade rear surface of the stator blade with the line types indicated separately for each particular case serve as parameters and therefore as a difference between the performance curves, For example, the dotted performance curve represents the stator blade with a planar region indicated by dots. The unbroken performance curves correspond here to a stator blade according to the prior art and are also used as a comparison. The corresponding shape of this stator blade is indicated by the continuous line in the sketch.

The diagram shows the effect of the planar region on the torque take-up behavior of the torque converter, as indicated by the curve group A. The curves rise with a large rotational speed ratio compared to the prior art depending on the position of the planar region. In contrast, the planar region has an imperceptible effect on the torque ratio, as is characterized by the curve group C. As a result of the relatively large torque take-up behavior of the impeller, the same torque can be transmitted by the impeller and turbine in the region of large rotational speed ratios when there is a relatively small differential rotational speed. This reduction in rotational speed is advantageous, for example, for economic purposes, for example for reducing the consumption of a motor vehicle.

### LIST OF REFERENCE SYMBOLS

10 Torque Converter
12 impeller
14 Turbine
16 Stator
18 Stator Blade
20 Blade Front Edge
22 Blade Rear Edge
24 Blade Front Surface
26 Blade Rear Surface
30 Planar Region
32 Surface Profile
34 junction
100 Rotational Axis
102 Axial Direction
α Angle
b Region Width
B Profile Depth

1. A hydrodynamic torque converter, comprising:
a housing;
a turbine;
an impeller arranged inside the housing; and
a stator having at least one stator blade arranged between the impeder and the turbine, the stator blade having a blade front edge facing the turbine, a blade rear edge facing the impeller, a blade front surface, which extends between the blade front edge and the blade rear edge and lies substantially opposite the turbine, and a blade rear surface, which comprises a planar region and lies substantially opposite the impeller, and the stator blade having a profile depth which defines a shortest distance between the blade front edge and the blade rear edge.

2. The hydrodynamic torque converter as claimed in claim 1, wherein the planar region has a region length, which is perpendicular with respect to a radial. direction and parallel to a tangent of the blade rear surface that is perpendicular to the radial direction.

3. The hydrodynamic torque converter as claimed in claim 2, wherein a ratio between. the region length and the profile depth is between 0 and 0.75.

4. The hydrodynamic torque converter as claimed in claim 2, further comprising a rotational axis, and the planar region forming an angle with an axial direction that runs parallel to the rotational axis.

5. The hydrodynamic torque converter as claimed in claim 4, wherein the angle of the planar region is between 0 degrees and 90 degrees.

6. The hydrodynamic torque converter as claimed in claim 5. Wherein the angle of the planar region is between 0 degrees and 60 degrees.

7. The hydrodynamic torque converter as claimed in claim 1, wherein the blade rear surface is substantially convex and the blade front surface is substantially concave.

8. The hydrodynamic torque converter as claimed in claim 1, wherein the stator blade has substantially an airfoil profile.

9. The hydrodynamic torque convener as claimed in claim 1, wherein the stator blade has an NACA profile when viewed in a cross-section perpendicular to a radial direction.

10. The hydrodynamic torque converter as claimed in claim 1, further comprising a junction extending continuously between the planar region and the blade rear surface.

11. The hydrodynamic torque converter as claimed in claim 3, wherein the region length and/or the angle are variable in the radial direction over an extent of the stator blade.
